(19) United States
(12) Patent Application Publication
(10) Pub. No.: US 2007/0266309 A1
(43) Pub. Date: Nov. 15, 2007

(54) Document transfer between document editing software applications

(76) Inventor: Royston Sellman, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/432,560

(22) Filed: May 12, 2006

(51) Int. Cl. G06F 17/00; G06F 7/00

(52) U.S. Cl. 715/513; 715/530; 715/517; 715/515; 707/100

(57) ABSTRACT

A method and system are provided for exporting a document structure from an electronic document representation containing multiple document structures. A document editing tool is used to identify multiple document portions relating to the document structure to be exported, and including at least one text document portion. The multiple document portions are associated with code which identifies the structure and style of the text within each text document portion and which identifies the geometry of the multiple document portions. The code and the text content is exported in a format which is independent of the document editing tool, to facilitate syndication of documents.

### FIELD OF THE INVENTION

This invention relates to the transfer of documents or document portions between different software applications, and relates to a method, system and a computer program product for such document transfer.

### RELATED ART

Layout design tools are used to prepare documents for printing, for example high volume printing tasks required for publication of materials such as newspapers.

Frequently, there are document portions which are to be repeated in different publications, and these portions may for example take the form of news articles or advertisements. Different publications will have different house styles and layouts, and the document portions to be introduced into a given publication will need to be re-formatted to different extents in order to adhere to the house style. This sharing of document portions is known as syndication.

Various restrictions may also be applied to the manner in which the content can be adjusted. Some content, such as newspaper articles, can be paraphrased, restyled and reflowed freely wherever they are syndicated. Other content, such as bylined reports from third party agencies or pre-designed advertising material may need to maintain content and some aspects of the layout. Other content, such as crosswords and TV guides may require even more strict adherence to the content and layout.

Text editors and layout design tools are used to design the documents for publication. These text editors and layout design tools obtain content from a Content Management System (CMS), and some CMS applications allow the tagging of content which could be used to express some of the limitations outlined above. There is, however, no standard mechanism by which the text editors and layout design tools can access these CMS tags. These tags are also lost when data is exchanged between different Content Management Systems, for example if different systems are used by different publishers between which content is to be syndicated.

There are a number of different technologies and formats which have emerged as tools for defining document content and structure, and some of these are discussed briefly below.

Extensible Markup Language (XML) is a markup language much like HyperText Markup Language (HTML). XML and HTML were designed with different goals. XML was created to structure, store and to send information. Since XML is a cross-platform, software and hardware independent tool for transmitting information, XML data can be exchanged between incompatible systems. In practice, computer systems and databases may contain data in incompatible formats. Converting the data to XML creates data that can be read by many different types of applications, and this greatly reduces this complexity of exchanging data between systems.

Various other formats have been built upon the platform created by XML. One example of particular relevance to the publishing of documents is the Extensible Stylesheet Language Formatting Objects (XSL-FO). This is an XML based markup language describing the formatting of XML data for output to screen, paper or other viewable media.

The above developments have enabled the production of increasingly sophisticated material for Digital Publishing. Production of such material relies upon the creation of complex document designs that have sections which can be filled with variable content, known as flows. This variable content is, for example, to be obtained from a database, and may occupy a variable area as well as having variable content. The physical location of a document set aside for such a flow (of variable data) is often termed a “copyhole”.

Primarily to address this variable nature of data to be inserted in to the copyholes of a document template, the Personalized Print Markup Language (PPML) has been developed, and is again an XML based format. PPML reduces the complexity of print jobs, especially when colour, images and personalised elements are being used. PPML makes efficient use of reusable content (termed “resources”), and makes the rasterisation process more efficient. PPML-T is a further development particularly for digital press applications, and defines a template which can be merged with data on the fly.

### SUMMARY OF THE INVENTION

According to a first aspect of the invention, there is provided a method of exporting a document structure from an electronic document representation containing multiple document structures, the method comprising:
using a document editing tool, selecting multiple document portions relating to the document structure to be exported and including at least one text document portion;
operating the document editing tool to cause the multiple document portions to be associated with code which identifies the structure and style of the text within each text document portion and which identifies the geometry of the multiple document portions;
operating the document editing tool to store the code and the text content in a format which is independent of the document editing tool.

According to a second aspect of the invention, there is provided a method of transferring a document structure from an electronic document representation containing multiple document structures, between first and second document editing tools, the method comprising:
using the first editing tool:
   selecting multiple document portions relating to the document structure to be exported and including at least one text document portion;
   causing the multiple document portions to be associated with code which identifies the structure and style of the text within each text document portion and which identifies the geometry of the multiple document portions; and
   causing the code and the text content to be stored in a format which is independent of the document editing tool; and
using the second editing tool:
   importing the multiple document portions including the code and the text content and causing the structure and style code to be applied to the text content; and
   editing the document structure.

According to a third aspect of the invention, there is provided a document editing tool computer program comprising code for implementing a method of:
receiving user input selecting multiple document portions relating to a common document structure to be exported from the editing tool, and including at least one text document portion;
associating the multiple document portions with code which identifies the structure and style of the text within each text document portion and which identifies the geometry of the multiple document portions;
storing the code and the text content in a format which is independent of the document editing tool.

According to a fourth aspect of the invention, there is provided an editing tool system for editing documents for publication, comprising a computer on which a computer program is operated which implements a method of:
receiving user input identifying multiple document portions relating to a common document structure to be exported from the editing tool, and including at least one text document portion;
associating the multiple document portions with code which identifies the structure and style of the text within each text document portion and which identifies the geometry of the multiple document portions;
storing the code and the text content in a format which is independent of the editing tool.

### BRIEF DESCRIPTION OF THE DRAWINGS

For a better understanding of the invention, embodiments will now be described, purely by way of example, with reference to the accompanying drawings, in which:

FIG. 1 shows an example of a page layout of a document for high volume printing, and including different articles/stories;

FIG. 2 shows in greater detail the structure of one of the stories;

FIG. 3 shows how the document portions relating to a story are selected using method of the invention;

FIG. 4 shows how the selected document portions are exported;

FIG. 5 shows how the selected document portions are imported;

FIG. 6 shows how the imported story can be re-edited; and

FIG. 7 shows a system of the invention.

### DETAILED DESCRIPTION OF THE INVENTION

Examples of the invention provide a method, system and a computer program product for enabling the export of a document structure, such as a story, article or advertisement from a document editing software package into a neutral, platform-independent format, whilst preserving attributes such as layout, style and relative positioning of document portions. Multiple document portions which relate to the document structure to be exported are given visible labels, and these portions are exported together with code which identifies the structure and style of the text within each text document portion and which identifies the geometry of the multiple document portions.

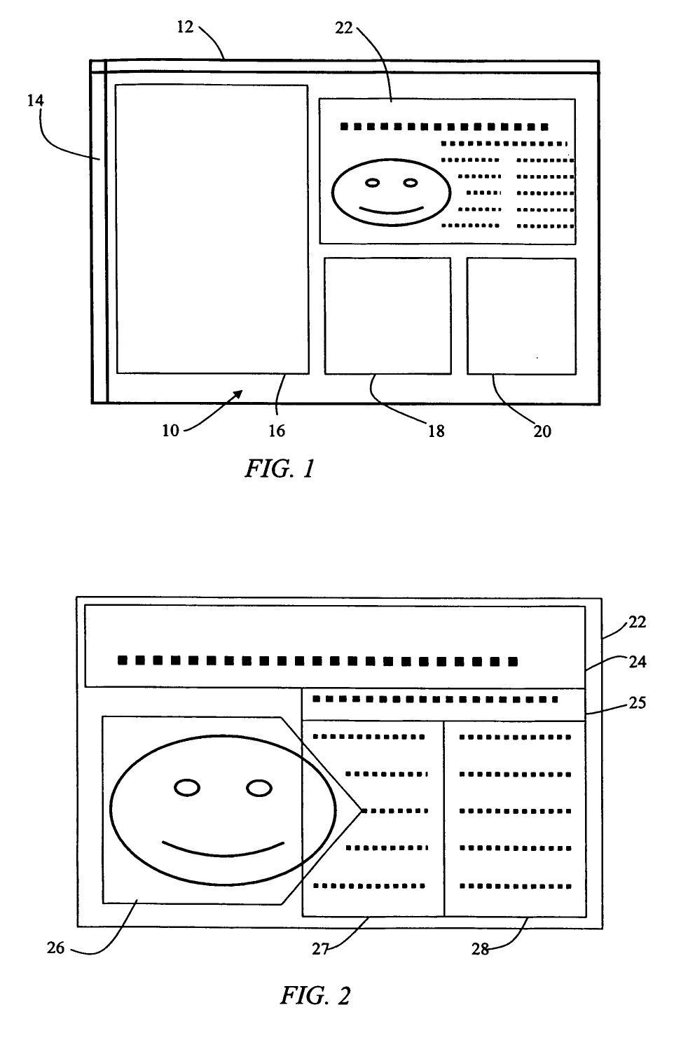

FIG. 1 shows an example of a page layout of a document for high volume printing. FIG. 1 shows the document as viewed on the screen of a computer running a document editing and layout tool, such as Quark XPress. The screen includes a main area 10 and horizontal and vertical tool bars 12,14. There are a number of standard document editing tools for preparing documents for publication, and these will be well known to those skilled in the art. The range of functions provided by these standard editing tools will not be described. The invention relates to the provision of additional functionality to be incorporated into such standard editing packages, and only this additional functionality will be described in detail.

As shown in FIG. 1, the document has a number of different sections 16, 18, 20, 22. In the case of a newspaper, these different sections will be different stories, advertisements, crosswords etc. In this description and claims, the term “document structure” is used to indicate one such story, article or advertisement. A document structure thus typically comprises a number of different document portions, which are assembled in a certain way to give the desired visual impact and to fit in with a general house style of the publication.

FIG. 1 shows schematically content for only one of the document structures 22, in the form of an article, and FIG. 2 shows in greater detail how this article is constructed.

As shown in FIG. 2, the article (which is a document structure using the terminology as defined above) has five different portions 24,25,26,27,28. A main title 24 extends the full width of the article 22. A sub-title 25 is positioned to the right, with an image 26 to the left. The main text of the article is arranged as two columns 27,28 beneath the sub-title 25, and the text in the left column 27 wraps around the border of the image 26.

The portions are implemented as copyholes, and have a certain geometry into which data (text or image) is fitted. Copyholes are used extensively with printing applications, to enable a layout to be defined and content to be inserted. These copyholes are a standard part of document layout tools.

It can be seen that in order to obtain the desired visual appearance of the article 22, various attributes must be defined, in addition to the actual text wording and image file. These attributes relate to:
text structure, such as the location of paragraph breaks, chapters, continuations, references, footnotes, and other word processing type attribute;
text style, such as the text face, text font and size, text alignment, justification, use of drop capitals, subscripts and superscripts;
the geometry, such as the sizes, shapes and relative positions of the different portions 24 to 28;
layering and clipping, such as the requirement for the text to wrap around the image.

Even when an article is to be shared (syndicated) between different publications, some or all of these attributes may need to be altered so that the visual appearance of the article matches the house style of the publication.

Within a give editing tool, a cut-and-paste type operation can be used to move or copy a given article. However, this operation does not provide a cross-platform solution to the transfer of content for syndication. The use of metadata has been proposed to provide a text description of the required document attributes, when the document text and images are exported from one platform to another. There is, however, no platform-independent mechanism for efficiently implementing this approach.

An alternative practice is to distribute entire document files with all of the associated style and structure information, and to identify which part of the entire document (using separate data) is the part for syndication. Clearly, this is an inefficient document transfer technique and is also difficult between different software applications which have incompatible file formats.

The invention provides an extension to design layout tools in the form of a software extension, which enables the designer to:
identify and label document portions (fragments) which relate to a common article, namely a common document structure;
tag these document portions with information (metadata) concerning content, structure and layout. This metadata can provide constraints on the re-use of the data;
export the document portions and the tags to a platform-independent format; and
import document portions and tags from the platform-independent format.

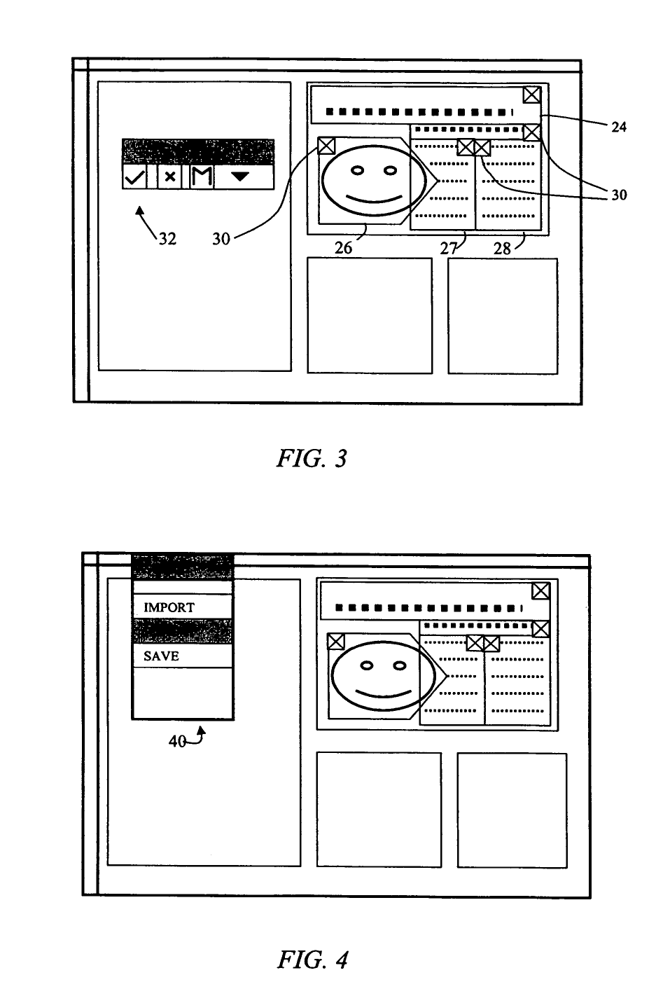

FIG. 3 shows how the document portions relating to a story are selected using the software extension of the invention.

The different document portions 26 to 28 are flagged by the designer, and the flagged portions are identified by a marker 30. A menu 32 entitled “Story Selector” is shown for the operation of flagging (with the tick symbol) or unflagging (with the cross symbol) the different document portions. Furthermore, metadata can be added to a selected document portion (with the “M” symbol). This metadata can be in the form of written text, with re-use instructions, for example specifying attributes which must not be changed.

In computational terms this ‘selection’ can be manifested by the addition of tags in the document date structure at points which define the selected part of the document, or in a related date structure from which the ‘selected’ part of the document may be ascertained. Alternatively, another way in which ‘selection’ of the parts of the document may be manifested, is by copying the selected document part to a memory. Other ways are also possible.

The selected story can then be exported, as shown in FIG. 4. As shown, a drop down menu 40 provides options of importing, exporting or saving a story.

The export function groups the flagged portions, and prepares these as an XML document to describe the text content, text style, text structure and copyhole layout. In addition to the layout information relating to the appearance of the article, the additional information (metadata) about constraints on the re-use of the data portions is also exported in XML format. The images and fonts are typically prepared using binary (for example bitmap) formats.

The XML document can use different formats to express the different information in the most efficient and platform-independent manner. For example, a compound document can be generated which uses PPML and XSL:FO (both of which are XML-based). PPML holds layout information and image references (for re-usable content, otherwise known as resources), whereas XSL:FO is used for text content, structure and style. These XSL:FO objects are embedded in the PPML and kept locally separate using standard namespace techniques.

The software extension uses newly-defined XML attributes (with separate namespaces) to allow the insertion of the metadata.

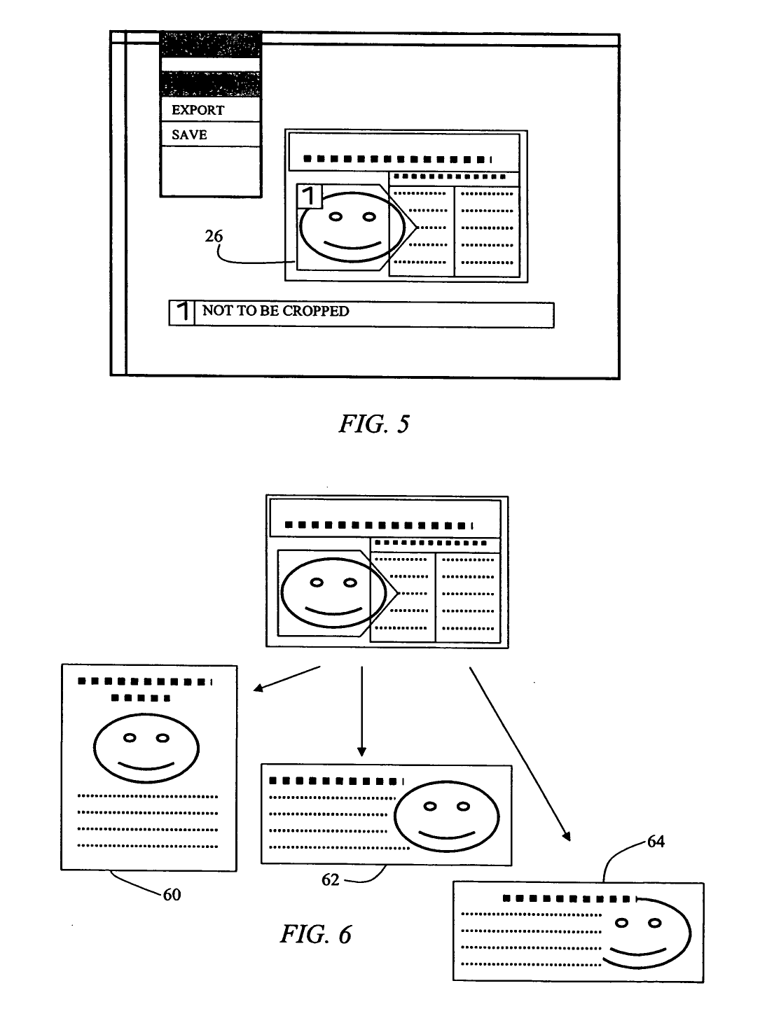

FIG. 5 shows how the selected document portions are imported into a blank document. As shown, the article is reproduced with preserved layout and style. In addition, any metadata is displayed. In the example shown, the document portion 26 containing the image is provided with metadata “Not to be cropped”, indicating that the image must be displayed in its entirety.

The document structure can be imported to the tool used to design the document or to a different document editing and layout tool. This compatibility requires each document layout tool to be provided with a parser based on standard. XML technology, and which additionally recognizes the newly defined attributes and namespaces used for the insertion of metadata relating to individual document portions. This parser then controls the display of the metadata as shown in FIG. 5.

Once a story has been imported, it can be re-edited using the document layout tool in conventional manner. FIG. 6 shows how the imported story can be edited to change to one column format with the image above the text (example 60), to a format with text that wraps around the image with the image to the right (example 62) or to a format with text that is layered over the image and is in a rectangular copyhole (example 64).

Of course, after the story data and associated metadata has been imported, it can be edited in any known manner using the layout tool.

The invention can be implemented using APIs (Application Programming Interfaces) which are provided as part of the design layout tool, for example Quark XPress or Adobe InDesign. These APIs allow the user interface to be extended by software adapters or “plugins”. The adapters are then distributed to all members of the syndication group, and all support the new XML schema which defines the metadata tags and supports the other layout data.

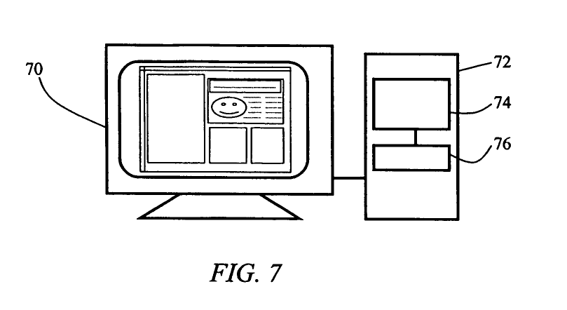

FIG. 7 shows a system of the invention, which comprises a screen 70, a computer 72 on which is running a conventional layout design tool 74 such as Quark XPress. The invention is implemented as the adapter 76, which is a software product, written for example using C and C++ code, and implementing the additional functionality described above.

The invention provides designers with increased control and ease of use in the authoring and management of content that is intended for syndication. Small entities (document structures) can be identified within a larger entity (in publishing terms known as a “title”), and attributes can be set that specify literal, structural, spatial and stylistic constraints on the re-use of the document structure. The exported data defining the documents structure and these re-use constraints can then be distributed within a syndication group, even when different members of the group use different layout design tools.

The re-use constraints may indicate, for example, that exact wording is to be maintained, or that a byline (identifying the author) is to be preserved. Other examples may be limitations on permitted changes to colours or size etc.

Those skilled in the art will realise that the above embodiments are purely by way of example and that modification and alterations are numerous and may be made while retaining the teachings of the invention.

1. A method of exporting a document structure from an electronic document representation containing multiple document structures, the method comprising:
using a document editing tool, selecting multiple document portions relating to the document structure to be exported and including at least one text document portion;
operating the document editing tool to cause the multiple document portions to be associated with code which identifies the structure and style of the text within each text document portion and which identifies the geometry of the multiple document portions;
operating the document editing tool to store the code and the text content in a format which is independent of the document editing tool.

2. A method as claimed in claim 1, wherein the document structure comprises an article within a multiple-article document.

3. A method as claimed in claim 1, wherein selecting multiple document portions comprises labeling the portions with a tag.

4. A method as claimed in claim 3, wherein selecting multiple document portions further comprising providing re-use information concerning at least one document portion, and wherein operating the document editing tool to store the code and the text content further comprises operating the document editing tool to store the re-use information.

5. A method as claimed in claim 4, wherein the code comprises XML code for the text content, text style, text structure and geometry, and binary code for images and fonts, and wherein the re-use information is provided as code associated with XML attributes.

6. A method as claimed in claim 1, wherein the code comprises XML code for the text content, text style, text structure and geometry, and binary code for images and fonts.

7. A method as claimed in claim 6, wherein the XML code comprises PPML and XSL:FO code.

8. A method as claimed in claim 1, wherein the multiple document portions comprise at least one image portion.

9. A method as claimed in claim 8, wherein the step of operating the document editing tool to store the code and the text content storing further comprises operating the document editing tool to store the image content.

10. A method of transferring a document structure from an electronic document representation containing multiple document structures, between first and second document editing tools, the method comprising:
using the first editing tool:
selecting multiple document portions relating to the document structure to be exported and including at least one text document portion;
causing the multiple document portions to be associated with code which identifies the structure and style of the text within each text document portion and which identifies the geometry of the multiple document portions; and
causing the code and the text content to be stored in a format which is independent of the document editing tool; and
using the second editing tool:
importing the multiple document portions including the code and the text content and causing the structure and style code to be applied to the text content; and
editing the document structure.

11. A method as claimed in claim 10, wherein editing the document structure using the second editing tool comprises reflowing the text document portions into a different layout.

12. A method as claimed in claim 11, wherein the different layout comprises a different column set.

13. A method as claimed in claim 10, wherein the document structure comprises an article within a multiple-article document.

14. A method as claimed in claim 10, wherein selecting multiple document portions comprises labeling the portions with a tag.

15. A method as claimed in claim 14, wherein selecting multiple document portions further comprising providing re-use information concerning at least one document portion, and wherein using the first document editing tool to store the code and the text content further comprises using the first document editing tool to store the re-use information.

16. A method as claimed in claim 15, wherein the code comprises XML code for the text content, text style, text structure and geometry, and binary code for images and fonts, and wherein the re-use information is provided as code associated with XML attributes.

17. A method as claimed in claim 10, wherein the code comprises XML code for the text content, text style, text stricture and geometry, and binary code for images and fonts.

18. A method as claimed in claim 17, wherein the XML code comprises PPML and XSL:FO code.

19. A method as claimed in claim 10, wherein the multiple document portions comprise at least one image portion.

20. A method as claimed in claim 19, wherein the step of causing the code and the text content to be stored further comprises causing the image content to be stored.

21. A method as claimed in claim 10, wherein the first document editing tool comprises an extended Quark application.

22. A document editing tool computer program comprising code for implementing a method of:
receiving user input selecting multiple document portions relating to a common document structure to be exported from the editing tool, and including at least one text document portion;
associating the multiple document portions with code which identifies the structure and style of the text within each text document portion and which identifies the geometry of the multiple document portions;
storing the code and the text content in a format which is independent of the document editing tool.

23. A computer program as claimed in claim 22, further for implementing a method of:
receiving re-use information concerning at least one document portion, and storing the re-use information in the format which is independent of the document editing tool.

24. A computer program as claimed in claim 23, wherein the code comprises XML code for the text content, text style, text structure and geometry, and binary code for images and fonts, and wherein the re-use information is provided as code associated with XML attributes.

25. A computer program as claimed in claim 22, wherein the code comprises XML code for the text content, text style, text stricture and geometry, and binary code for images and fonts.

26. A computer program as claimed in claim 25, wherein the XML code comprises PPML and XSL:FO code.

27. A computer program as claimed in claim 22, comprising an adapter for a document layout editing software application.

28. An editing tool system for editing documents for publication, comprising a computer on which a computer program is operated which implements a method of:
receiving user input identifying multiple document portions relating to a common document structure to be exported from the editing tool, and including at least one text document portion;
associating the multiple document portions with code which identifies the structure and style of the text within each text document portion and which identifies the geometry of the multiple document portions;
storing the code and the text content in a format which is independent of the editing tool.
